(19) United States
(12) Patent Application Publication
(10) Pub. No.: US 2011/0183184 A1
(43) Pub. Date: Jul. 28, 2011

(54) BATTERY MODULE FOR AN ENGINE

(75) Inventor: YIHSONG JAN, Taipei City (TW)

(73) Assignee: Exa Energy Technology Co., Ltd.

(21) Appl. No.: 12/692,594

(22) Filed: Jan. 23, 2010

(51) Int. Cl. H01M 6/42; F02P 15/00

(52) U.S. Cl. 429/156; 123/143 R

(57) ABSTRACT

A battery module includes a lithium iron phosphate cell set and a lead acid cell set. The lithium iron phosphate cell set includes at least one lithium iron phosphate cell arranged in series, and the lead acid cell set includes at least one lead acid cell arranged in series. A capacity of the lithium iron phosphate cell set is 1-20% of that of the lead acid cell set. The lithium iron phosphate cell set and the lead acid cell set are connected with each other in parallel, so as to increase the discharge C-rate of the battery module. Also, electronic devices powered by the battery module of the present invention can work for a longer period of time, while the price of the battery module of the present invention is significantly lowered compared with a battery module using high capacity lithium iron phosphate cell set only.

### BACKGROUND OF THE INVENTION

1. Field of the Invention

The present invention relates to a battery module, and more particularly to a battery module for an engine.

2. Description of the Prior Art

Conventional internal combustion engines are commonly installed in automotive vehicles. When operation, the cylinder(s) of the engine is filled with fuel, and then the fuel is ignited by a spark plug and explodes to drive the engine. The electricity needed during the ignition of the spark plug is supplied by a battery module. The bigger the combustion degree of the fuel is, the more power the engine generates. In order to fulfill bigger combustion degree, the spark plug should ignite for a longer period of time, which requires the increase of the current the battery module supplies.

However, conventional lead acid cells have smaller discharge C-rate. As the vehicle requires lager engine speed during acceleration or hill climbing, the total current supplied by both the lead acid cells and the generator is still insufficient for the ignition of the spark plug. As such, the acceleration performance and the gradeability of the vehicle are barely satisfactory.

On the other hand, the lithium iron phosphate cells can discharge at a higher C-rate, so that they are adapted for the vehicles and provide sufficient electricity as the vehicles accelerate or climb a hill. Nevertheless, the lithium iron phosphate cells are expensive. Even though lithium iron phosphate cells with smaller capacity, such as 10 Ah, can still reach the C-rate of lithium iron phosphate cells with a capacity of 55 Ah, other concerns are arisen. For example, electronic devices installed on the vehicle, such as the alarm system, GPS device and etc., still consume energy. As such, the lithium iron phosphate cells with a capacity of only 10 Ah go dead quickly. Therefore, the application of the lithium iron phosphate cells in the vehicle battery field is limited.

### SUMMARY OF THE INVENTION

The main object of the present invention is to provide an inexpensive battery module with satisfactory discharge C-rate.

To achieve the above and other objects, the battery module of the present invention includes a lithium iron phosphate cell set and a lead acid cell set. The lithium iron phosphate cell set includes at least one lithium iron phosphate cell arranged in series, and the lead acid cell set includes at least one lead acid cell arranged in series. The lithium iron phosphate cell set and the lead acid cell set are connected with each other in parallel. A capacity of the lithium iron phosphate cell set is 1-20% of that of the lead acid cell set.

As a result, the discharge C-rate of the battery module is increased. Also, electronic equipments powered by the battery module of the present invention can work for a longer period of time, while the price of the battery module of the present invention is significantly lowered compared with a battery module using high capacity lithium iron phosphate cell set only.

The present invention will become more obvious from the following description while taken in connection with the accompanying drawings, which show, for purpose of illustrations only, the preferred embodiment(s) in accordance with the present invention.

### BRIEF DESCRIPTION OF THE DRAWINGS

FIG. 1 shows the relationship of torque to RPM of vehicles using different battery modules;

FIG. 2 shows the relationship of power to RPM of vehicles using different battery modules.

### DETAILED DESCRIPTION OF THE PREFERRED EMBODIMENTS

A battery module of the present invention is adapted for an internal combustion engine of an automotive vehicle or an emergency generating engine of a building. The engine includes at least one spark plug, and the battery module electrically connects to the spark plug and supplies the spark plug with electricity during ignitions.

The battery module of the present invention includes a lithium iron phosphate cell set and a lead acid cell set. More specifically, the lithium iron phosphate cell set includes at least one lithium iron phosphate cell arranged in series, and the lead acid cell set includes at least one lead acid cell arranged in series, too. Then, the lithium iron phosphate cell set and the lead acid cell set are electrically connected with each other in parallel. A capacity of the lithium iron phosphate cell set is determined to be 1-20% of that of the lead acid cell set.

In a preferred embodiment of the present invention, the capacity of the lithium iron phosphate cell set is 10 Ah in total, and the capacity of the lead acid cell set is 55 Ah in total. That is, the capacity of the lithium iron phosphate cell set is 18.2% of that of the lead acid cell set, in which the lithium iron phosphate cell set of the present embodiment includes four lithium iron phosphate cells electrically connected in series, and the lead acid cell set includes six lead acid cells electrically connected in series.

When an internal combustion engine utilizes a battery module of the present invention as a starter battery thereof, the torque and power output thereof are satisfactory.

Experiments have been implemented to test the performance of a vehicle utilizes three different battery modules as its starter battery. The three battery modules includes a battery module utilizing 4S lithium iron phosphate cells of 10 Ah in total, a battery module utilizing 6S lead acid cells of 55Ah in total, and a battery module utilizing both the above mentioned 4S lithium iron phosphate cells and 6S lead acid cells, i.e. the battery of the present invention. The tested vehicle is TOYOTA CAMRY™ 2000 C.C. The voltage values of the lithium iron phosphate cell set and the lead acid cell set are both about 12-13 V, i.e. they are substantially the same to work in parallel.

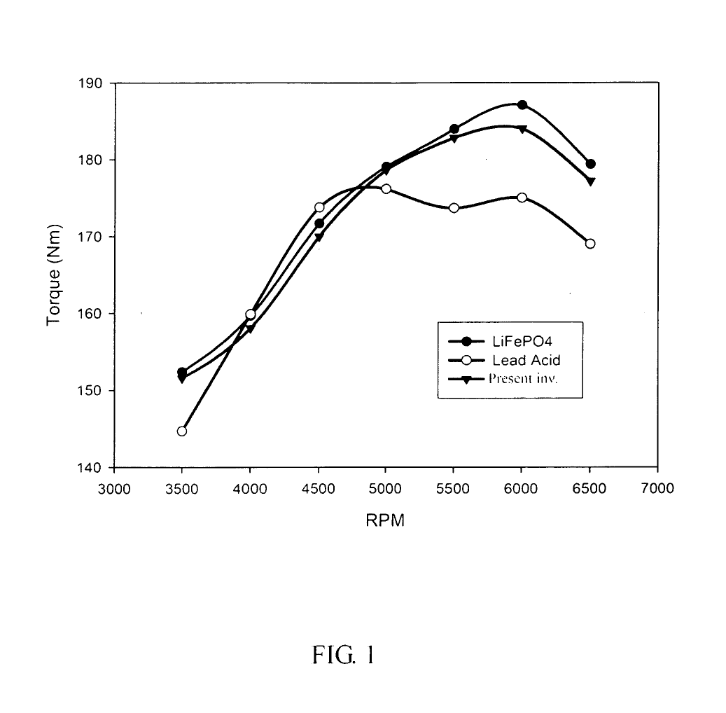

First, please refer to FIG. 1. The torque output performance of the vehicle utilizing the battery module of the present invention is very close to the vehicle utilizing lithium iron phosphate cells only. In addition, the torque output performance of the vehicle utilizing the battery module of the present invention exceeds that of the vehicle utilizing lead acid cells only by about 10-15% at high engine speed (more than 5000 rpm).

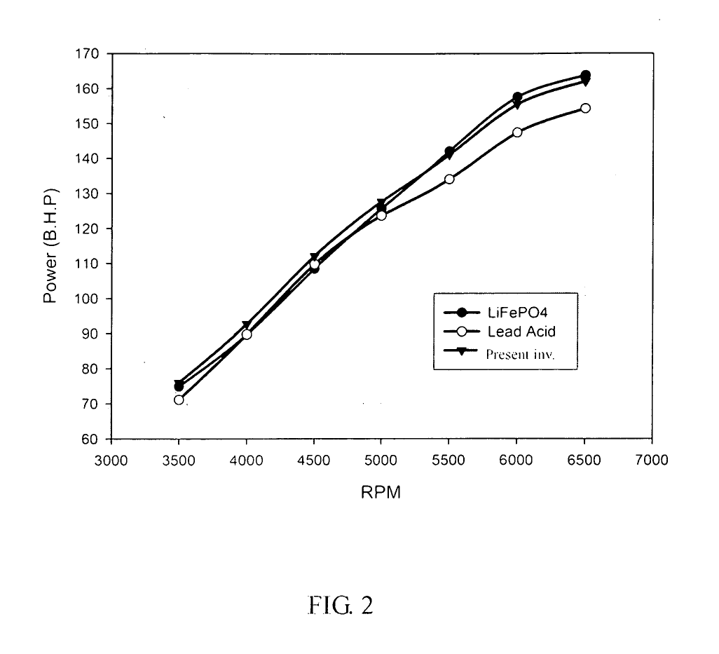

Please refer to FIG. 2. Likewise, the power output performance of the vehicle utilizing the battery module of the present invention is similar to that of the vehicle utilizing the lithium iron phosphate cells only and exceeds that of the vehicle utilizing lead acid cells only by about 10-15% at high engine speed.

Apparently, the discharge C-rate of the battery module of the present invention utilizing both the lithium iron phosphate cell set and the lead acid cell set is adequate to increase the ignition temperature and time of the spark plug, so as to further enhance the power and torque output of the engine. Compared with the battery module utilizing lithium iron phosphate cells with high capacity only, the battery module of the present invention is advantageous in price and meets the requirement of the market, which helps the application of lithium iron phosphate cells enter the vehicle starter battery field. Further, compared with the battery module utilizing lithium iron phosphate cells with low capacity only, the battery module of the present invention is advantageous in that the price still lies in a reasonable range, and the endurance of the battery module is significantly elevated. As such, situations that the battery module goes dead resulting from the electricity consumption by the electronic devices on the vehicle can be resolved or at least mitigated significantly.

In addition, the experiments provide a solid evidence that a capacity ratio of 1-20% of the lithium iron phosphate cell set to the lead acid cell set is sufficient to enable the engine using the battery module of the present invention to perform well in power and torque output. Also, the cost of the battery module can be controlled within a reasonable price. That is, the present invention satisfies both the practicability and the economy concerns.

What is claimed is:

1. A battery module for an engine, comprising a lithium iron phosphate cell set and a lead acid cell set, the lithium iron phosphate cell set comprising at least one lithium iron phosphate cell arranged in series, the lead acid cell set comprising at least one lead acid cell arranged in series, the lithium iron phosphate cell set and the lead acid cell set being connected. with each other in parallel, a capacity of the lithium iron phosphate cell set being 1-20% of that of the lead acid cell set.

2. The battery module of claim 1, wherein the capacity of the lithium iron phosphate cell set is 10 Ah, and the capacity of the lead acid cell set is 55 Ah.

3. The battery module of claim 1, wherein the lithium iron phosphate cell set comprises four lithium iron phosphate cells arranged in series.

4. The battery module of claim 1, wherein the lead acid cell set comprises six lead acid cells arranged in series.

5. The battery module of claim 1, wherein the battery module is adapted for an internal combustion engine of an automotive vehicle.

6. The battery module of claim 5, wherein the engine comprises at least one spark plug, the battery module electrically connects to the spark plug and supplies the spark plug with electricity during ignitions.
